(19) United States
(12) Patent Application Publication
(10) Pub. No.: US 2011/0315786 A1
(43) Pub. Date: Dec. 29, 2011

(54) Atomizing Unit and Atomizer Including the Same

(75) Inventor: Tsuguji Kambayashi, Kyoto-fu (JP)

(73) Assignee: MURATA MANUFACTURING CO., LTD., Nagaokakyo-shi (JP)

(21) Appl. No.: 13/228,528

(22) Filed: Sep. 9, 2011

Related U.S. Application Data
(63) Continuation of application No. PCT/JP2010/054300, filed on Mar. 15, 2010.

(30) Foreign Application Priority Data
Mar. 31, 2009 (JP) 2009-084878

(51) Int. Cl. B05B 3/14

(52) U.S. Cl. 239/102.2

(57) ABSTRACT

An atomizer that includes an atomizing unit having a piezoelectric vibrator, an elastic film, and a first liquid feeder. The piezoelectric vibrator includes a vibrating film and a piezoelectric body. An atomization region in the center of the vibrating film has through holes. The vibrating film is mounted on the piezoelectric body. The piezoelectric body causes the vibrating film to vibrate. The elastic film is disposed to face the atomization region. The elastic film is directly or indirectly secured to the piezoelectric vibrator. The first liquid feeder is supported by the elastic film so as to face the atomization region of the vibrating film with a gap interposed therebetween. The first liquid feeder feeds a liquid to the atomization region.

### CROSS REFERENCE TO RELATED APPLICATIONS

The present application is a continuation of International Application No. PCT/JP2010/054300, filed Mar. 15, 2010, which claims priority to Japanese Patent Application No. JP2009-084878, filed Mar. 31, 2009, the entire contents of each of these applications being incorporated herein by reference in their entirety.

### FIELD OF THE INVENTION

The present invention relates to atomizing units. Specifically, the present invention relates to an atomizing unit including a vibrating film that atomizes a liquid and a liquid feeder that feeds the liquid to the vibrating film, and also relates to an atomizer including the atomizing unit.

### BACKGROUND OF THE INVENTION

Conventionally, various atomizers using a piezoelectric vibrator, such as that described in Patent Literature 1, have been proposed. FIG. 9 is a schematic cross-sectional view illustrating part of an atomizer described in Patent Literature 1.

As illustrated in FIG. 9, an atomizer 100 includes a vibrating plate 102 secured at one end to a piezoelectric vibrator 101 and having a plurality of through holes (not shown). The atomizer 100 also includes a liquid feeding structure 103 as a means of feeding a liquid to the vibrating plate 102. The liquid feeding structure 103 includes glass tubes 104 for sucking the liquid up to the vicinity of the vibrating plate 102, and hydrophilic resin films 105 for covering end portions of the glass tubes 104 adjacent to the vibrating plate 102. With the hydrophilic resin films 105 in the atomizer 100, the liquid sucked up through the glass tubes 104 to the vicinity of the vibrating plate 102 comes into contact with the vibrating plate 102. It is thus possible to efficiently feed the liquid to the vibrating plate 102 and maintain a high level of liquid feeding capability over a long period of time.

Patent Literature 1: Japanese Unexamined Patent Application Publication No. 5-329411

However, even though the hydrophilic resin films 105 are provided in the atomizer 100, it is necessary to secure the glass tubes 104 such that tips of the glass tubes 104 are located at exact positions very close to the vibrating plate 102. Specifically, if a gap between the tips of the glass tubes 104 and the vibrating plate 102 is too large, the liquid cannot be sufficiently fed to the vibrating plate 102. Conversely, if a gap between the tips of the glass tubes 104 and the vibrating plate 102 is too small, the tips of the glass tubes 104 may come into contact with the vibrating plate 102. If the glass tubes 104 come into contact with the vibrating plate 102, the glass tubes 104 and the vibrating plate 102 may be damaged. Therefore, it is necessary to mount the glass tubes 104 to the atomizer 100 with high positional accuracy.

Additionally, to prevent relative displacement between the glass tubes 104 and the vibrating plate 102 over time, it is necessary to firmly mount the piezoelectric vibrator 101 and the glass tubes 104. This makes it difficult to manufacture the atomizer 100.

### SUMMARY OF THE INVENTION

An object of the present invention is to provide an easy-to-manufacture atomizing unit including a vibrating film that atomizes a liquid and a liquid feeder that feeds the liquid to the vibrating film, and an atomizer including the atomizing unit.

An atomizing unit according to the present invention includes a piezoelectric vibrator, an elastic film, and a first liquid feeder. The piezoelectric vibrator includes a vibrating film and a piezoelectric body. An atomization region in a center of the vibrating film has through holes. The vibrating film is mounted on the piezoelectric body, which causes the vibrating film to vibrate. The elastic film is disposed to face the atomization region. The elastic film is directly or indirectly secured to the piezoelectric vibrator. The first liquid feeder is supported by the elastic film so as to face the atomization region of the vibrating film with a gap interposed therebetween. The first liquid feeder feeds a liquid to the atomization region.

In a specific aspect of the atomizing unit according to the present invention, the first liquid feeder is a member that feeds the liquid by capillary action.

In another specific aspect of the atomizing unit according to the present invention, the piezoelectric body has a cylindrical shape, and the vibrating film is mounted on one end of the piezoelectric body in an axial direction. This configuration can improve vibration efficiency of the vibrating film and thus can make it possible to reduce power consumption.

In another specific aspect of the atomizing unit according to the present invention, the piezoelectric body is a disk-shaped member having first and second principal surfaces and provided with an opening in a center thereof, the piezoelectric vibrator has a first electrode on the first principal surface of the piezoelectric body and a second electrode on the second principal surface of the piezoelectric body, and the vibrating film is mounted on the first electrode of the piezoelectric vibrator such that the atomization region is located at a position corresponding to the opening of the piezoelectric body.

An atomizer according to the present invention includes the atomizing unit of the present invention described above, an atomizer body, and a second liquid feeder. The atomizing unit is mounted on the atomizer body. The atomizer body has a reservoir in which the liquid is stored. The second liquid feeder feeds the liquid stored in the reservoir to the first liquid feeder.

In a specific aspect of the atomizer according to the present invention, the elastic film has a mounting portion outside a portion on which the piezoelectric vibrator is mounted, and the atomizing unit is mounted on the atomizer body at the mounting portion. In this configuration, the piezoelectric vibrator is mounted on the atomizer body, with the elastic film having elasticity interposed therebetween. Therefore, for example, as compared to the case where the piezoelectric vibrator is directly mounted on the atomizer body, it is possible to suppress degradation of vibration efficiency of the piezoelectric vibrator caused by mounting the piezoelectric vibrator on the atomizer body. It is thus possible to realize high atomization efficiency and reduce power consumption of the atomizer.

In another specific aspect of the atomizer according to the present invention, the elastic film has an opening at one end of the mounting portion adjacent to the portion on which the piezoelectric vibrator is mounted. This configuration makes the piezoelectric vibrator less easily restrained by the atomizer body. It is thus possible to more effectively suppress degradation of vibration efficiency of the piezoelectric vibrator caused by mounting the piezoelectric vibrator on the atomizer body.

In another specific aspect of the atomizer according to the present invention, the opening of the elastic film has a long narrow shape along the portion of the elastic film on which the piezoelectric vibrator is mounted. This configuration makes the piezoelectric vibrator less easily restrained by the atomizer body. It is thus possible to more effectively suppress degradation of vibration efficiency of the piezoelectric vibrator caused by mounting the piezoelectric vibrator on the atomizer body.

In another specific aspect of the atomizer according to the present invention, the opening of the elastic film is provided in plurality, the openings of the elastic film are spaced from each other, bridge portions are formed between adjacent ones of the openings, and the bridge portions connect the portion of the elastic film on which the piezoelectric vibrator is mounted and the mounting portion of the elastic film. This configuration makes the piezoelectric vibrator less easily restrained by the atomizer body. It is thus possible to more effectively suppress degradation of vibration efficiency of the piezoelectric vibrator caused by mounting the piezoelectric vibrator on the atomizer body.

In the present invention, both the first liquid feeder and the vibrating film are supported by the elastic film. Since this facilitates accurate positioning of the first liquid feeder with respect to the vibrating film, the atomizing unit of the present invention can be easily manufactured.

Since the elasticity of the elastic film allows displacement of the first liquid feeder, it is possible to suppress contact between the vibrating film and the first liquid feeder. The suppression of contact between the vibrating film and the first liquid feeder can prevent the first liquid feeder from inhibiting the vibration of the vibrating film. It is thus possible to realize high atomization efficiency.

### BRIEF DESCRIPTION OF THE DRAWINGS

FIG. 1 is a schematic exploded perspective view of an atomizer according to a first embodiment.

FIG. 2 is a schematic cross-sectional view of the atomizer according to the first embodiment.

FIG. 3 is a schematic plan view of an elastic film and a piezoelectric vibrator.

FIG. 4 is a schematic cross-sectional view which is an enlarged view of part of a vibrating film.

FIGS. 5(a) to 5(c) illustrate a form of cylindrical breathing vibration of the piezoelectric vibrator.

FIG. 6 is a schematic cross-sectional view of an atomizer according to a second embodiment.

FIG. 7 is a schematic cross-sectional view of an atomizer according to a third embodiment.

FIG. 8 is a schematic cross-sectional view which is an enlarged view of part of a vibrating film according to the third embodiment.

FIG. 9 is a schematic cross-sectional view illustrating part of an atomizer described in Patent Literature 1.

### DETAILED DESCRIPTION OF THE INVENTION

The present invention will be made apparent by describing a specific embodiment of the present invention with reference to the drawings.

### First Embodiment

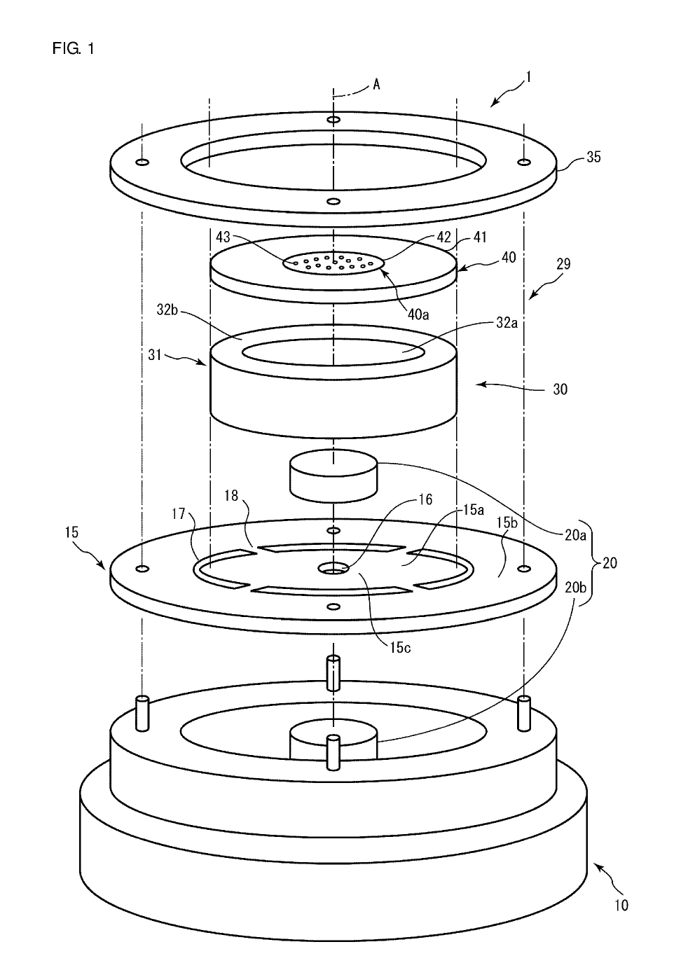

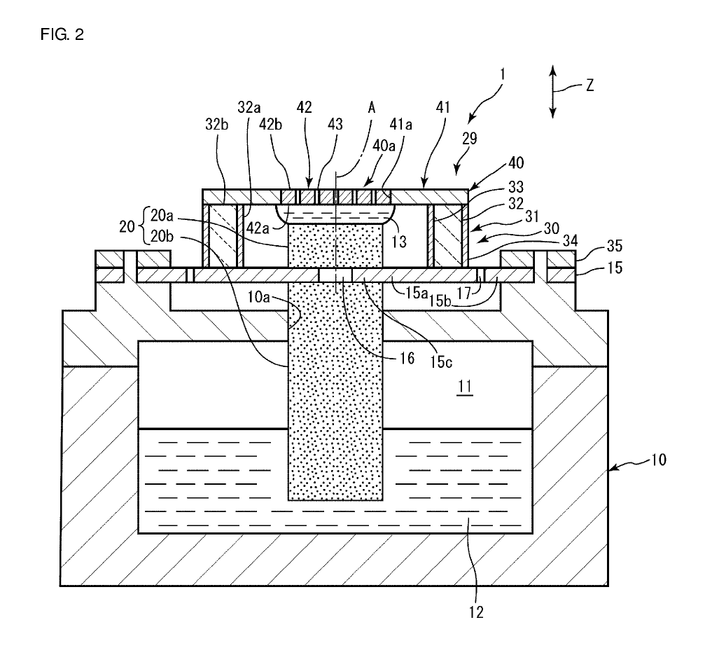

FIG. 1 is a schematic exploded perspective view of an atomizer according to the present embodiment. FIG. 2 is a schematic cross-sectional view of the atomizer according to the present embodiment. As illustrated in FIG. 1 and FIG. 2, an atomizer 1 includes an atomizing member 30, an atomizer body 10, and a liquid feeder 20. In the present embodiment, the atomizing member 30 and a first liquid feeder 20a (described below) form an atomizing unit 29.

The atomizer body 10 can be made, for example, of synthetic resin, metal, ceramic, glass, or paper. As illustrated in FIG. 2, there is a reservoir 11 inside the atomizer body 10. A liquid 12 to be atomized is stored in the reservoir 11. The liquid 12 is not particularly limited. Examples of the liquid 12 include water, aqueous solution, or organic solvent such as alcohol or oil. The liquid 12 may be, for example, an air freshener, deodorant, insecticide, repellent, perfume, or lotion.

The atomizing unit 29 is mounted on the atomizer body 10 with an elastic film 15 interposed therebetween. Alternatively, the atomizing unit 29 may be directly mounted on the atomizer body 10.

As illustrated in FIG. 1 and FIG. 2, the atomizing member 30 includes a cylindrical piezoelectric vibrator 31 and a vibrating film 40. As illustrated in FIG. 2, the piezoelectric vibrator 31 includes a cylindrical piezoelectric body 32. The piezoelectric body 32 is made of piezoelectric material. The piezoelectric material for forming the piezoelectric body 32 is not particularly limited. For example, the piezoelectric material may be lead zirconate titanate (PZT) ceramic. The dimensions of the piezoelectric body 32 are not particularly limited. For example, the piezoelectric body 32 may be 10 mm in inside diameter, 12 mm in outside diameter, and 3.5 mm in height.

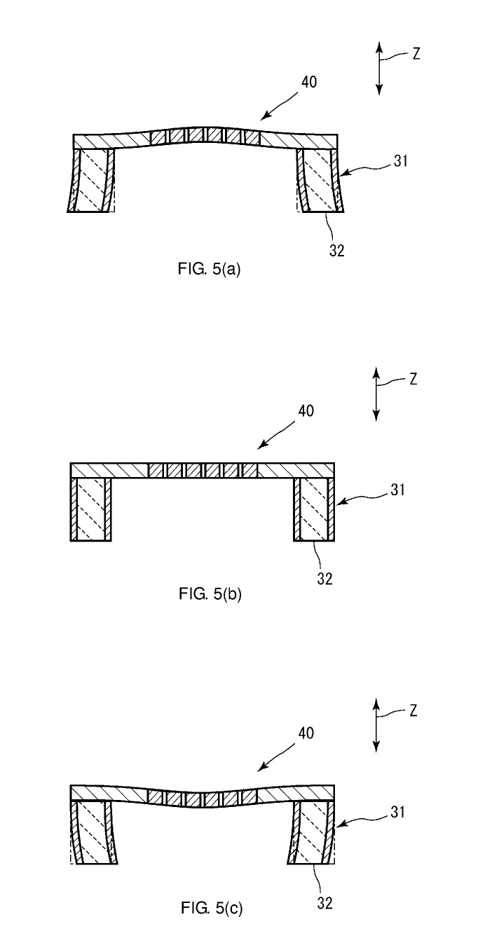

A first electrode 33 is on an inner periphery of the piezoelectric body 32, and a second electrode 34 is on an outer periphery of the piezoelectric body 32. By applying a voltage of, for example, about 3 kV/mm between the first and second electrodes 33 and 34, the piezoelectric body 32 is polarized in a radial direction of the electrode structure 32. Therefore, when an alternating voltage is applied between the first and second electrodes 33 and 34, the piezoelectric vibrator 31 vibrates in the radial direction of the piezoelectric body 32 (hereinafter referred to as “cylindrical breathing vibration”). The cylindrical breathing vibration occurs in at least one of d31 mode and d33 mode. Specifically, the piezoelectric vibrator 31 vibrates as illustrated in FIGS. 5(a) to 5(c). That is, as illustrated in FIG. 5(a) to FIG. 5(c), application of a voltage causes the cylindrical piezoelectric body 32 to radially expand and contract repeatedly due to the piezoelectric effect. In response to this, the vibrating film 40 vibrates in an up-and-down direction z.

Note that the form of cylindrical breathing vibration illustrated in FIGS. 5(a) to 5(c) is merely an example, and may be changed depending on the frequency of the cylindrical breathing vibration. Specifically, FIGS. 5(a) to 5(c) illustrate an example in which the vibrating film 40 is displaced downward when the piezoelectric vibrator 31 radially contracts at a portion remote from the vibrating film 40. However, depending on the frequency, the vibrating film 40 may be displaced upward when the piezoelectric vibrator 31 radially contracts at a portion remote from the vibrating film 40. In other words, the phase of vibration of the vibrating film 40 may be displaced 180° depending on the frequency of the cylindrical breathing vibration.

As described above, in the present embodiment, the vibration of the vibrating film 40 is excited by the cylindrical breathing vibration of the cylindrical piezoelectric body 32. Therefore, for example, as compared to the case where vibration of a vibrating film is exited by a transverse effect of a disk-shaped piezoelectric body, the vibration of the vibrating film 40 can be excited more efficiently. It is thus possible to realize high atomization efficiency, which can reduce power consumption of the atomizer 1. In other words, the level of vibration can be increased with the same power consumption. The increase in the level of vibration can increase the layout area of through holes 43 used for atomization, increase the number of the through holes 43, and realize a larger amount of spray. Additionally, atomized droplets can be sprayed farther.

Specifically, for example, in an atomizer using a piezoelectric body which vibrates due to the transverse effect, the atomization voltage is about 20 Vpp. In contrast, in the atomizer 1 of the present embodiment using the piezoelectric body 32 which produces cylindrical breathing vibration, the atomization voltage can be, for example, as low as about 10 Vpp. Also, the power consumption of the atomizer using the piezoelectric body which vibrates due to the transverse effect is about 10 mW, whereas the power consumption of the atomizer 1 using the piezoelectric body 32 which produces cylindrical breathing vibration can be as low as 1 mW or less. This result also shows that by using an elastic body which produces cylindrical breathing vibration, it is possible to realize high atomization efficiency and low power consumption.

In the present embodiment, the liquid feeder 20 feeds the liquid 12 to a surface of the vibrating film 40 adjacent to the piezoelectric vibrator 31. In other words, the liquid feeder 20 is disposed on the side opposite the spraying side of the vibrating film 40. Thus, since the spraying is not obstructed by the piezoelectric vibrator 31, it is possible to increase the spraying angle and realize spraying over a wide area.

The vibration of the piezoelectric body 32 may either be self-excited or externally excited. However, in the case of external excitation, in which the adhesion of liquid to the surface of the piezoelectric vibrator 31 causes changes in resonance frequency, it is necessary to add a compensating circuit for allowing the frequency to respond. Therefore, it is preferable that vibration of the piezoelectric body 32 be self-excited.

A waveform of a voltage applied to the piezoelectric body 32 may be, for example, a sine waveform, a sawtooth waveform, or a square waveform. In particular, a square waveform is preferable as a waveform of a voltage applied to the piezoelectric body 32. This is because application of a square wave to the piezoelectric body 32 makes it possible to achieve higher atomization efficiency. On/off control of atomization is realized by turning on/off the voltage applied to the piezoelectric body 32. Alternatively, on/off control of atomization may be realized by modulating the amplitude or frequency of the waveform of the voltage applied to the piezoelectric body 32.

The first and second electrodes 33 and 34 are not particularly limited, as long as they can apply a voltage to the piezoelectric body 32. For example, the first and second electrodes 33 and 34 can be made of metal, such as Ag, Al, Cu, Au, Pt, Ni, or Sn, or alloy, such as Cr/Ni alloy or Cu/Ni alloy.

If the first and second electrodes 33 and 34 have low water resistance, the surfaces of the first and second electrodes 33 and 34 may be provided with a protective film. In particular, it is preferable that the surface of the second electrode 34 be provided with a protective film. This is to suppress degradation of the second electrode 34 caused by cavitation erosion resulting from adhesion of sprayed liquid onto the surface of the second electrode 34. The protective film is not particularly limited, as long as it is more water-resistant than the first and second electrodes 33 and 34. For example, the protective film can be made of elastic resin, such as silicon resin, polyurethane resin, or polyester resin.

The first and second electrodes 33 and 34 can be formed, for example, by a thin-film forming method such as sputtering or evaporation, or by a method using conductive paste.

As illustrated in FIG. 1 and FIG. 2, the vibrating film 40 is mounted over an opening 32a of the piezoelectric body 32 on one side in an axial direction A. Specifically, in the present embodiment, the vibrating film 40 is mounted on an end face 32b of the piezoelectric body 32 on one side in the axial direction A. The vibrating film 40 does not necessarily have to be provided outside the piezoelectric body 32. The vibrating film 40 may be provided inside the piezoelectric body 32, that is, in a hollow portion of the cylindrical piezoelectric body 32. In other words, the vibrating film 40 may be mounted to the inner periphery of the piezoelectric body 32. The thickness of the vibrating film 40 is not particularly limited, but can be, for example, about 0.5 mm.

The vibrating film 40 is a film that vibrates in the up-and-down direction z as the piezoelectric body 32 vibrates. The vibrating film 40 is not particularly limited, as long as it can vibrate in the up-and-down direction z. It is preferable, however, that the vibrating film 40 be a film that vibrates mainly in a primary mode (fundamental mode) as the piezoelectric vibrator 31 vibrates. This can increase the displacement of the vibrating film 40. It is thus possible to increase an atomization area of the vibrating film 40. Therefore, it is possible to provide a large number of through holes 43 (described below) over a wide area, achieve high atomization efficiency, and increase the possible amount of atomization.

The material of the vibrating film 40 is not particularly limited. For example, the vibrating film 40 can be made of resin, ceramic, or metal. In particular, it is preferable that the vibrating film 40 be made of ceramic. This can increase the thickness of the vibrating film 40 and facilitate vibration of the vibrating film 40 predominantly in a primary mode.

Specifically, in the present embodiment, the vibrating film 40 includes a film body 41 attached to an end of the piezoelectric vibrator 31 and a through-holed member 42 separated from the film body 41. The film body 41 has an opening 41a in the center thereof, and the through-holed member 42 is mounted in the opening 41a.

The shape of the through-holed member 42 is not particularly limited. For example, the through-holed member 42 can be about 4.9 mm in diameter and about 0.5 mm in thickness. In the present embodiment, the opening 41a of the film body 41 is smaller in diameter than the through-holed member 42. The through-holed member 42 is secured to the film body 41 by being pressed into the opening 41a. The method for securing the through-holed member 42 to the film body 41 is not particularly limited. For example, the through-holed member 42 of metal can be secured to the film body 41 of ceramic by brazing or soldering. In this case, the film body 41 may be plated before being brazed or soldered. For example, if the through-holed member 42 is a resin film with low stiffness, the through-holed member 42 may be bonded to the film body 41 by an adhesive, or welded to the film body 41.

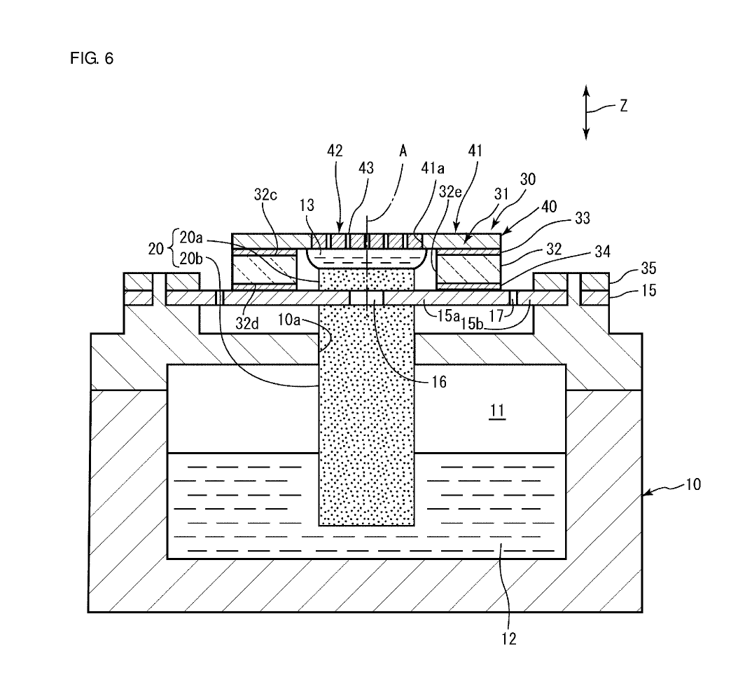

The through-holed member 42 has a plurality of through holes (nozzle holes) 43 that pass through the through-holed member 42 in the thickness direction. The through holes 43 are for spraying the liquid 12. As illustrated in FIG. 4, each of the through holes 43 has a countersink 43a, a connecting portion 43b, and a large-diameter portion 43c. The countersink 43a is open to a lower surface 42a of the through-holed member 42. The countersink 43a is tapered from the lower surface 42a toward an upper surface 42b. A lower end of the countersink 43a communicates with the connecting portion 43b. The connecting portion 43b has a substantially cylindrical shape with a diameter substantially equal to that of the lower end of the countersink 43a. The diameter of the connecting portion 43b can be determined appropriately depending on the viscosity of the liquid 12 to be atomized. The diameter of the connecting portion 43b can be, for example, about 5 μm to 20 μm. A lower end of the connecting portion 43b communicates with the large-diameter portion 43c. The large-diameter portion 43c has a cylindrical shape with a diameter larger than that of the connecting portion 43b. For convenience of drawing, the through holes 43 are schematically illustrated as cylindrical holes in FIG. 2 and FIG. 6 (described below).

The present embodiment has described an example in which each of the through holes 43 has the countersink 43a, the connecting portion 43b, and the large-diameter portion 43c. However, the shape of the through holes 43 is not limited to that described in the present embodiment. For example, the through holes 43 may be tapered or cylindrical in shape.

The film body 41 and the through-holed member 42 may be made of either the same material or different materials. In particular, the through-holed member 42 is preferably made of resin. This is because if the through-holed member 42 is made of resin, the through holes 43 can be formed more easily than in the case where, for example, the through-holed member 42 is made of ceramic.

The method for forming the through holes 43 can be selected appropriately depending on, for example, the dimensions of the through holes 43 and the material of the through-holed member 42. If the through-holed member 42 is made of ceramic, the through holes 43 can be formed, for example, by electroforming. If the through-holed member 42 is made of resin, the through holes 43 can be formed, for example, by laser such as green-YAG laser, UV-YAG laser, or excimer laser, by chemical etching, or by press-working.

As illustrated in FIG. 1 and FIG. 2, the piezoelectric vibrator 31 is secured to the elastic film 15 which is mounted by a retaining plate 35 on the atomizer body 10. Under the vibrating film 40, the elastic film 15 is disposed to face the through-holed member 42 that constitutes an atomization region 40a of the vibrating film 40, the atomization region 40a having the through holes 43.

The material of the elastic film 15 is not particularly limited. For example, the elastic film 15 can be made of resin, such as polyimide resin or PET resin.

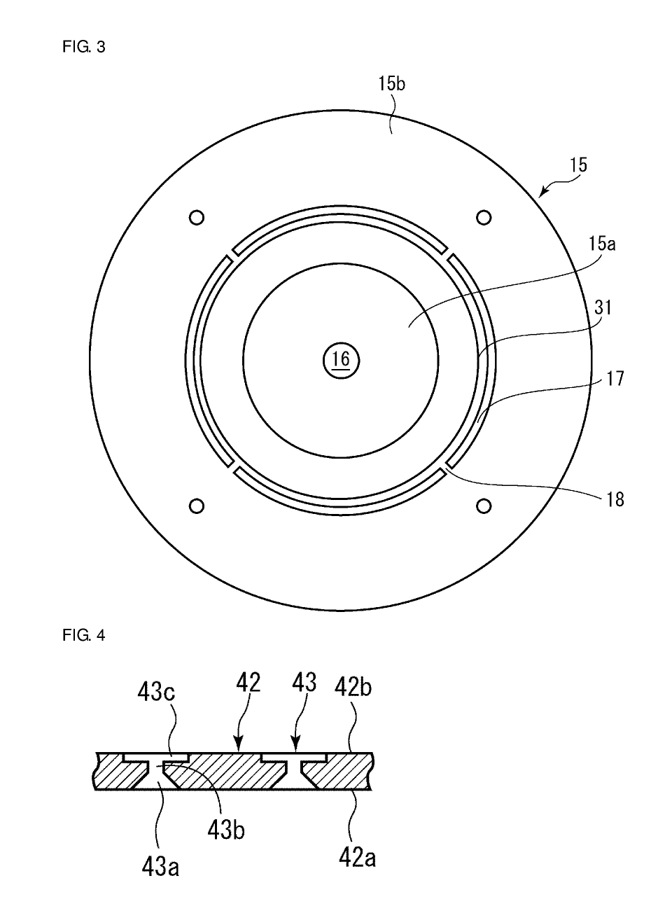

As illustrated in FIG. 1 and FIG. 3, the elastic film 15 is disk-shaped. As illustrated in FIG. 2, the first liquid feeder 20a is supported at a central portion 15c of the elastic film 15. The first liquid feeder 20a communicates with a second liquid feeder 20b (described below) through an opening 16 in the central portion 15c of the elastic film 15. The first liquid feeder 20a faces the atomization region 40a of the vibrating film 40 with a gap 13 interposed therebetween. The distance of the gap 13 can be determined appropriately depending on, for example, the viscosity of a liquid such that the gap 13 can be filled with the liquid. For example, the distance of the gap 13 can be set to about 0.05 mm to 0.8 mm.

The first liquid feeder 20a is capable of feeding the liquid 12 fed by the second liquid feeder 20b (described below) through the gap 13 to the vibrating film 40. The first liquid feeder 20a and the second liquid feeder 20b may be members that feed the liquid 12, for example, by capillary action. Specifically, the first and second liquid feeders 20a and 20b can be made of, for example, a bundle of fibers or a structure of plates which can produce a capillary action. The bundle of fibers may contain micro-gaps. Examples of the bundle of fibers which can produce a capillary action include felt, nonwoven fabric, nonwoven paper, and capillaries. If the first and second liquid feeders 20a and 20b are made of soft material, such as felt, nonwoven fabric, or nonwoven paper, it is possible to reduce inhibition of vibration of the vibrating film 40 (atomization inhibition) caused by contact between the first and second liquid feeders 20a and 20b and the vibrating film 40, and to suppress damage to the vibrating film 40 caused by contact between the first and second liquid feeders 20a and 20b and the vibrating film 40.

As illustrated in FIG. 1 and FIG. 3, the piezoelectric vibrator 31 is secured outside the central portion 15c of the elastic film 15 on which the first liquid feeder 20a is mounted. The elastic film 15 has a mounting portion 15b outside an inner portion 15a on which the piezoelectric vibrator 31 is mounted. The atomizing unit 29 is mounted on the atomizer body 10 at the mounting portion 15b of the elastic film 15.

As illustrated in FIG. 3, at an edge of the mounting portion 15b adjacent to the inner portion 15a, a plurality of arc-shaped openings 17 are spaced from one another along the inner portion 15a in the circumferential direction. A plurality of bridge portions 18 that connect the inner portion 15a and the mounting portion 15b are defined by the plurality of openings 17.

As illustrated in FIG. 2, the second liquid feeder 20b is supported by being inserted into an opening 10a of the atomizer body 10. A lower end of the second liquid feeder 20b reaches the lower part of the reservoir 11. An upper end of the second liquid feeder 20b reaches the lower end face of the elastic film 15. The second liquid feeder 20b feeds the liquid 12 in the reservoir 11 to the first liquid feeder 20a. In the present embodiment, the second liquid feeder 20b and the first liquid feeder 20a form the liquid feeder 20 that feeds the liquid 12 in the reservoir 11 to the lower surface of the vibrating film 40.

In response to vibration of the vibrating film 40 caused by cylindrical breathing vibration of the piezoelectric vibrator 31, the liquid fed to the vibrating film 40 is atomized and sprayed through the through holes 43.

As described above, in the present embodiment, both the first liquid feeder 20a and the vibrating film 40 are supported by the elastic film 15. This facilitates accurate positioning of the first liquid feeder 20a with respect to the vibrating film 40. Therefore, the atomizer 1 of the present embodiment can be easily manufactured.

For example, if the vibrating film 40 is deformed toward the first liquid feeder 20a, which is supported by the elastic film 15 having elasticity, the first liquid feeder 20a is displaced along with the deformation of the vibrating film 40 in the direction of deformation of the vibrating film 40. Therefore, it is possible to effectively suppress contact between the vibrating film 40 and the first liquid feeder 20a, and to effectively prevent damage to the vibrating film 40 and the first liquid feeder 20a. For effective prevention of damage to the vibrating film 40, it is preferable that the first liquid feeder 20a be made, for example, of soft felt, nonwoven fabric, or nonwoven paper.

When contact between the vibrating film 40 and the first liquid feeder 20a is suppressed, the first liquid feeder 20a can be prevented from inhibiting vibration of the vibrating film 40. It is thus possible to achieve high atomization efficiency.

A natural frequency of the elastic film 15 is, for example, about 1 kHz, which is typically smaller than frequencies at which the piezoelectric body 32 can be driven (i.e., a natural frequency of the piezoelectric body 32 (e.g., about 100 kHz) and its neighboring values). Therefore, as in the present embodiment, even through the piezoelectric vibrator 31 is supported by the elastic film 15, the vibration of the piezoelectric vibrator 31 is practically not transmitted to the elastic film 15. It is thus possible to suppress excitation of the first liquid feeder 20a supported by the elastic film 15, and thus to suppress generation of spray in the first liquid feeder 20a. Therefore, it is possible to efficiently feed the liquid 12 to the vibrating film 40 and increase the amount of spray.

The vibration of the piezoelectric vibrator 31 is not transmitted to the elastic film 15 and thus is not transmitted to the atomizer body 10. At the same time, the vibration of the piezoelectric vibrator 31 is not restrained by the atomizer body 10. Therefore, it is possible to suppress degradation of vibration efficiency of the piezoelectric vibrator 31 caused by mounting the piezoelectric vibrator 31 on the atomizer body 10. It is thus possible to achieve high atomization efficiency and reduce power consumption of the atomizer 1.

In the present embodiment, the openings 17 are provided between the inner portion 15a and the mounting portion 15b. This makes the piezoelectric vibrator 31 less easily restrained by the atomizer body 10. It is thus possible to more effectively suppress degradation of vibration efficiency of the piezoelectric vibrator 31 caused by mounting the piezoelectric vibrator 31 on the atomizer body 10. Instead of providing the openings 17, other structures with different second moments of area may be provided, or the piezoelectric vibrator 31 may be supported by support members with different acoustic impedances. Even in such cases, it is still possible, as in the case of providing the openings 17, to effectively confine the vibration of the piezoelectric vibrator 31.

Additionally, in the present embodiment, the openings 17 have a long and narrow shape along the inner portion 15a of the elastic film 15 on which the piezoelectric vibrator 31 is mounted. This makes the piezoelectric vibrator 31 less easily restrained by the atomizer body 10. It is thus possible to more effectively suppress degradation of vibration efficiency of the piezoelectric vibrator 31 caused by mounting the piezoelectric vibrator 31 on the atomizer body 10.

Also in the present embodiment, the inner portion 15a is connected to the mounting portion 15b by the bridge portions 18 between adjacent ones of the openings 17. This makes the piezoelectric vibrator 31 less easily restrained by the atomizer body 10. It is thus possible to more effectively suppress degradation of vibration efficiency of the piezoelectric vibrator 31 caused by mounting the piezoelectric vibrator 31 on the atomizer body 10.

Other preferred embodiments of the present invention will now be described. In the following description, components having substantially the same functions as those in the first embodiment are referred to by the same reference numerals and their description will be omitted.

### Second Embodiment

The first embodiment has described an example in which the piezoelectric vibrator 31 that produces cylindrical breathing vibration is used. In the present invention, however, the piezoelectric vibrator 31 is not particularly limited, as long as it allows the vibrating film 40 to vibrate. For example, the piezoelectric vibrator may be a disk-shaped piezoelectric vibrator that vibrates due to the transverse effect. In the present embodiment, an atomizer including a disk-shaped piezoelectric vibrator that vibrates due to the transverse effect will be described with reference to FIG. 6.

As illustrated in FIG. 6, an atomizer of the present embodiment is different from the atomizer 1 of the first embodiment only in terms of the configuration of the piezoelectric vibrator 31. In the present embodiment, the piezoelectric body 32 is disk-shaped. The piezoelectric body 32 has a circular opening 32e in the center thereof. The first electrode 33 is on a first principal surface 32c of the piezoelectric body 32, and the second electrode 34 is on a second principal surface 32d of the piezoelectric body 32. The vibrating film 40 is mounted on the first electrode 33 of the piezoelectric vibrator 31 such that the atomization region is located at a position corresponding to the opening 32e of the piezoelectric body 32.

In the present embodiment, application of an alternating voltage between the first and second electrodes 33 and 34 causes the piezoelectric body 32 to vibrate due to the transverse effect. This causes the vibrating film 40 to vibrate up and down, so that atomization takes place.

In the present embodiment, where the piezoelectric body 32 is disk-shaped, the distance between the elastic film 15 and the vibrating film 40 can be reduced. Therefore, it is possible to reduce the size of the atomizer and improve efficiency in feeding the liquid 12 to the vibrating film 40.

### Third Embodiment

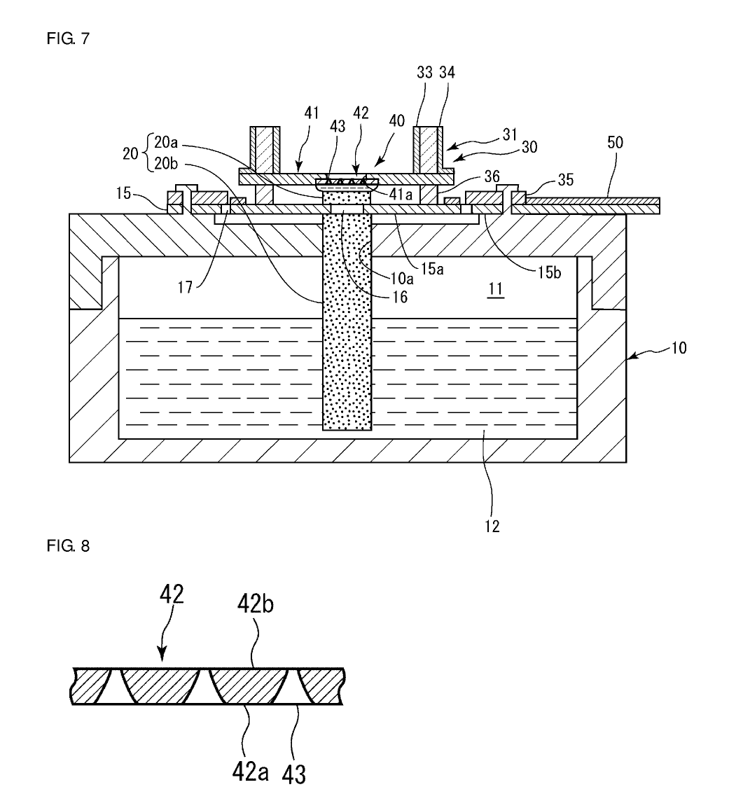

FIG. 7 is a schematic cross-sectional view of an atomizer according to a third embodiment. The first embodiment has described an example in which the piezoelectric vibrator 31 is disposed on one side of the vibrating film 40 adjacent to the atomizer body 10. However, the present invention is not limited to this configuration. For example, as illustrated in FIG. 7, the piezoelectric vibrator 31 may be disposed opposite the atomizer body 10 with respect to the vibrating film 40. In the present embodiment, the piezoelectric vibrator 31 is indirectly mounted on the elastic film 15 with a spacer 36 interposed therebetween. This allows the distance between the piezoelectric vibrator 31 and the elastic film 15 to be kept constant. The material of the spacer 36 is not particularly limited. The spacer 36 can be made, for example, of metal, resin, or ceramic.

As described above, when the piezoelectric vibrator 31 is indirectly mounted on the elastic film 15 with the spacer 36 interposed therebetween, the distance between the piezoelectric vibrator 31 and the elastic film 15 can be freely changed by varying the dimensions of the spacer 36 depending on, for example, the amplitude of the vibrating film 40 or the characteristics of the elastic film 15. For example, the distance between the piezoelectric vibrator 31 and the elastic film 15 can be made smaller than the linear dimension of the piezoelectric body 32.

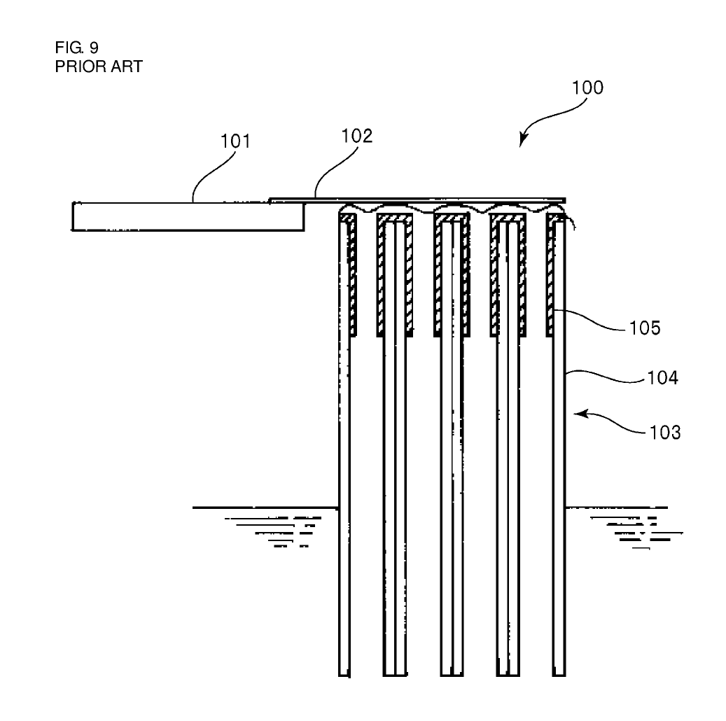

FIG. 8 is a schematic cross-sectional view which is an enlarged view of part of a vibrating film. In the present embodiment, as illustrated in FIG. 8, each of the through holes 43 is substantially tapered in radius from the lower surface 42a to the upper surface 42b. As illustrated in FIG. 7, the through-holed member 42 is fitted into a countersink in the film body 41. By fitting the through-holed member 42 into the countersink, the through-holed member 42 can be firmly joined to the film body 41.

In the present embodiment, there is an extraction electrode 50 to which the first and second electrodes 33 and 34 are connected. The extraction electrode 50 allows the first and second electrodes 33 and 34 to be extracted outside.

### Reference Numbers

1: atomizer

10: atomizer body

10a: opening

11: reservoir

12: liquid

13: gap

15: elastic film

15a: inner portion

15b: mounting portion

15c: central portion

16: opening

17: opening

18: bridge portion

20: liquid feeder

20a: first liquid feeder

20b: second liquid feeder

29: atomizing unit

30: atomizing member

31: piezoelectric vibrator

32: piezoelectric body

32a: opening

32b: end face

32c: first principal surface

32d: second principal surface

32e: opening

33: first electrode

34: second electrode

35: retaining plate

36: spacer

40: vibrating film

40a: atomization region

41: film body

41a: opening

42: through-holed member

42a: lower surface

42b: upper surface

43: through hole

43a: countersink

43b: connecting portion

43c: large-diameter portion

50: extraction electrode

1. An atomizing unit comprising:
a piezoelectric vibrator including a vibrating film with through holes in an atomization region in a center of the vibrating film, and a piezoelectric body on which the vibrating film is mounted, the piezoelectric body being configured to cause the vibrating film to vibrate;
an elastic film disposed to face the atomization region; and
a liquid feeder supported by the elastic film so as to face the atomization region of the vibrating film with a gap interposed therebetween, the liquid feeder being configured to feed a liquid to the atomization region.

2. The atomizing unit according to claim 1, wherein the liquid feeder is a member that feeds the liquid by capillary action.

3. The atomizing unit according to claim 1, wherein the elastic film is directly secured to the piezoelectric vibrator.

4. The atomizing unit according to claim 1, wherein the elastic film is indirectly secured to the piezoelectric vibrator.

5. The atomizing unit according to claim 4, further comprising a spacer interposed between the elastic film and the piezoelectric vibrator.

6. The atomizing unit according to claim 1, wherein the piezoelectric body has a cylindrical shape, and the vibrating film is mounted on one end of the piezoelectric body in an axial direction thereof.

7. The atomizing unit according to claim 1, wherein the piezoelectric body is a disk-shaped member having first and second principal surfaces and an opening in a center thereof, the piezoelectric vibrator has a first electrode on the first principal surface of the piezoelectric body and a second electrode on the second principal surface of the piezoelectric body, and the vibrating film is mounted on the first electrode of the piezoelectric vibrator such that the atomization region is located at a position corresponding to the opening of the piezoelectric body.

8. The atomizing unit according to claim 1, wherein the through holes include a countersink portion at a first end thereof, a cylindrical opening at a second end thereof, and a connecting portion connecting the countersink portion to the cylindrical opening, a diameter of the cylindrical opening being larger than a diameter of the connecting portion.

9. An atomizer comprising:
the atomizing unit according to claim 1, wherein the liquid feeder is a first liquid feeder;
an atomizer body on which the atomizing unit is mounted, the atomizer body having a reservoir in which the liquid is stored; and
a second liquid feeder configured to feed the liquid stored in the reservoir to the first liquid feeder.

10. The atomizer according to claim 9, wherein the elastic film has a mounting portion outside a portion on which the piezoelectric vibrator is mounted, and the atomizing unit is mounted on the atomizer body at the mounting portion.

11. The atomizer according to claim 10, wherein the elastic film has at least one opening between the mounting portion and the portion on which the piezoelectric vibrator is mounted.

12. The atomizer according to claim 11, wherein the at least one opening of the elastic film has an arc shape along the portion of the elastic film on which the piezoelectric vibrator is mounted.

13. The atomizer according to claim 12, wherein the at least one opening of the elastic film is a plurality of openings that are spaced from each other, bridge portions separate adjacent ones of the openings, and the bridge portions connect the portion of the elastic film on which the piezoelectric vibrator is mounted and the mounting portion of the elastic film.
